(19) United States
(12) Patent Application Publication
(10) Pub. No.: US 2023/0251488 A1
(43) Pub. Date: Aug. 10, 2023

(54) FOV EXPANSION DEVICE FOR USE IN A NEAR-EYE DISPLAY

(71) Applicant: Lumus Ltd., Ness Ziona (IL)

(72) Inventors: Eitan RONEN, Rechovot (IL); Naamah LEVIN, Rechovot (IL)

(21) Appl. No.: 18/015,107

(22) PCT Filed: Jul. 11, 2021
(86) PCT No.: PCT/IL2021/050848

§ 371 Date: Jan. 9, 2023

Related U.S. Application Data
(60) Provisional application No. 63/050,232, filed on Jul. 10, 2020.

(51) Int. Cl. G02B 27/01; G02B 27/18

(52) U.S. Cl. CPC G02B 27/0172; G02B 27/18; G02B 2027/0123; G02B 2027/011; G02B 5/1814

(57) ABSTRACT

A field of view (FOV) expansion device for use in a near-eye display includes a first surface which receives incident illumination from a projector of departure of the near-eye display. The incident illumination, which may consist of a multiplicity of incident illumination fields is characterized by an incident angular aperture. The expansion device is adjacent to a non-sequential (NS) optical element which projects output light to an observer. The refractive index of the device is greater than that of the NS optical element. A FOV expansion ratio, which is equal to the ratio between a projected angular aperture of the output light and an incident angular aperture of the incident illumination, is greater than or equal to a pre-determined threshold value. The first surface of the FOV expansion device is transparent in one embodiment and reflective in another.

### CROSS-REFERENCE TO RELATED APPLICATIONS

This application is related to and claims priority from the commonly owned US Provisional Patent Application U.S. 63/050,232, filed on Jul. 10, 2020, and entitled “FOV EXPANSION BETWEEN POD AND LOE”. The disclosure of the above provisional application is incorporated by reference in its entirety herein.

### FIELD OF THE INVENTION

The present invention relates to Near-Eye Display (NED) glasses, and in particular, to a waveguide-based device for field of view (FOV) expansion of a near-eye display.

### BACKGROUND OF THE INVENTION

Compact systems using near-eye displays typically project light from a Projector of Display (POD) to an Eye Motion Box (EMB). The projected light passes through a Non-Sequential (NS) optical element, such as a Light-guide Optical Element (LOE) which expands apertures of display, and into the EMB. The user experience of a viewer improves with the angular size of the FOV of the projected image.

In compact NED systems, one constraint on FOV size is the size of the POD, which must be small enough to conform with requirements placed on the form factor of the NED system. Additional constraints are placed on the maximum distortion and chromatic aberration that can be tolerated in the projected image.

### SUMMARY OF THE INVENTION

The invention provides an optical FOV Expansion (FE) device which couples the light from the POD into an NS optical element, and significantly expands the angular FOV of the projected image.

According to one aspect of the presently disclosed subject matter, there is provided an optical field of view (FOV) expansion device for use in a near-eye display. The device includes a first surface which receives incident illumination from a projector of display (POD) of the near-eye display, the incident illumination having an incident angular aperture. The device also includes a second surface forming a vertex angle with the first surface. The second surface is proximal and substantially parallel to a surface of a non-sequential (NS) optical element, which projects light having a projected angular aperture. A refractive index of the device is greater than that of the NS optical element. Furthermore, a FOV expansion ratio of the device, defined as a ratio between the projected angular aperture and the incident angular aperture, is greater than or equal to a pre-determined threshold value.

According to some aspects, the first surface of the device is optically transparent to the incident illumination.

According to some aspects, the first surface of the device optically reflects the incident illumination.

According to some aspects, a projected image aspect ratio is greater than a POD aspect ratio by a factor equal to the FOV expansion ratio.

According to some aspects, the pre-determined threshold value is 1.2.

According to some aspects, the FOV expansion ratio increases with an angle of incidence of the incident illumination.

According to some aspects, the angle of incidence of the incident illumination is between 35 degrees and 50 degrees.

According to some aspects, the refractive index of the device is between 1.70 and 1.94.

According to some aspects, the device consists of an optical flint glass material or an optical acrylic material.

According to some aspects, the vertex angle has a value between 35 degrees and 50 degrees.

According to some aspects, the NS optical element is a light-guide optical element.

According to some aspects, the incident illumination includes a multiplicity of incident illumination fields.

According to some aspects, the device introduces optical aberrations and/or optical distortions which are compensated by corrections applied to the incident illumination from the POD.

According to some aspects, the corrections are applied by a spatial light modulator and/or by corrective optical elements.

According to some aspects, the incident illumination is provided by one or more narrow-band illumination sources, so as to limit the effects of chromatic aberration.

According to some aspects, the NS optical element couples light out through a diffractive optical element.

### BRIEF DESCRIPTION OF THE DRAWINGS

The invention is herein described, by way of example only, with reference to the accompanying drawings. Like reference numerals are used to denote similar or like elements to the drawings.

FIG. 1: A schematic cross-sectional diagram of an exemplary FE device for coupling light into an LOE, according to a first embodiment of the invention.

FIG. 2: An exemplary graph illustrating the highly nonlinear relationship between an incident angle θ120 and a refraction angle θ130 at an interface between the FE device and the LOE.

FIG. 3: A schematic cross-sectional diagram of an exemplary FE device for coupling light into a LOE, according to a second embodiment of the invention

### DESCRIPTION OF THE INVENTION

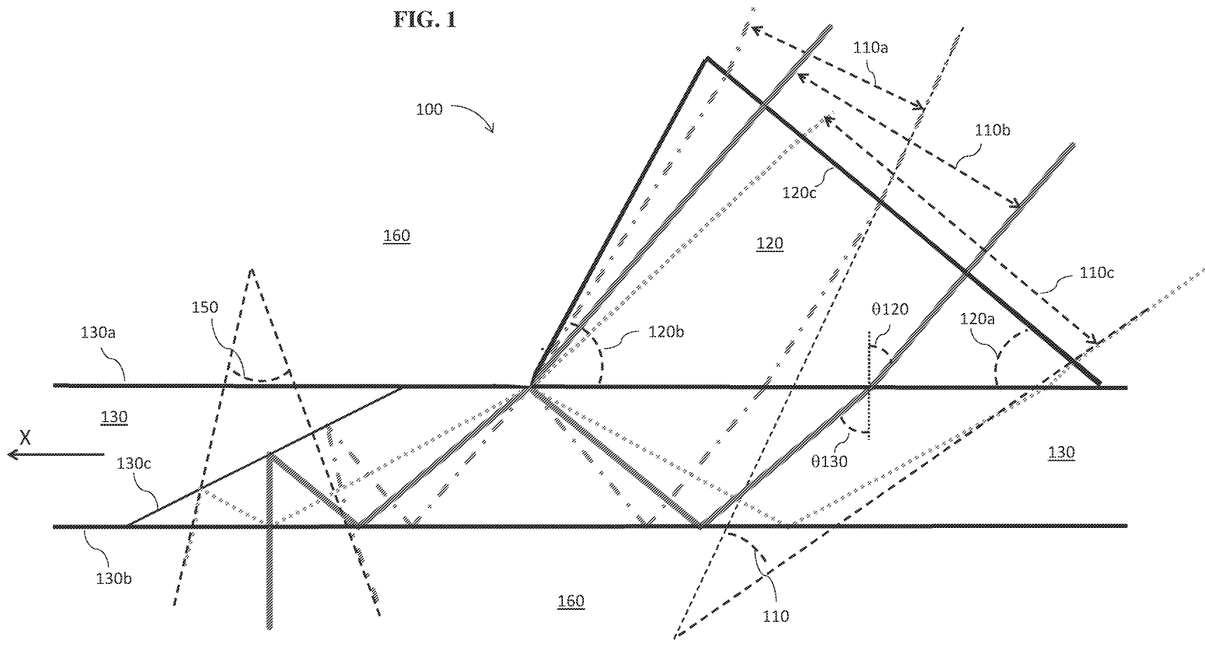

FIG. 1 shows a schematic cross-sectional diagram of an exemplary FE device 120 for coupling light into an LOE 130, according to a first embodiment 100 of the invention. Light from the POD enters the device 120 through surface 120c from multiple incident illumination fields 110a, 110b, and 110c. Each field is shown as extending in one-dimension between two limiting rays. The rays are distinguished by dot-dashed lines for field 110a, by solid lines for field 110b, and by dotted lines for field 110c. The incident angular aperture 110 corresponds to the angle subtended by light from all the illumination fields entering the device 120.

The FE device 120 is shown, for example, as having a prismatic shape, with a triangular cross-section having a first vertex angle 120a, a second vertex angle 120b, and a third vertex angle equal to 180°−(120a+120b). By way of example, the vertex angle 120a may be between 35 and 50 degrees.

The incident rays of the illumination field 110b are approximately orthogonal to the surface 120c, which is transparent and opposite the vertex angle 120b.

In order to provide an NED system having a compact form-factor, the FE device 120 is preferably comprised of a transparent optical glass or acrylic material having a relatively high refractive index (RI), denoted by n120; for example n120 may be in a range of 1.70 to 1.94. An exemplary optical glass material is an eco-friendly dense flint glass. The glass is cut and polished and bonded to the LOE 130 with an optical adhesive, according to methods known to those skilled in the art of optical manufacturing.

The LOE 130 is shown in cross-section as consisting of two major surfaces 130a and 130b substantially parallel to the X-axis, where surface 130a is proximal to the FE device 120. Internal surface 130c of the LOE is a wholly or partially reflecting surface. More generally, the LOE 130 may contain two or more internal surfaces which are at least partially reflecting, or even a few sets of partially reflective surfaces, as disclosed in Australian patent application no. AU 2007203022, entitled “A Light Guide Optical Device”, to Y. Amitai, published on Jul. 19, 2007. The LOE 130 is comprised for example of a transparent optical glass or acrylic material having a refractive index, denoted by n130, which is typically less than n120. For example, n130 may be in a range of 1.5 to 1.6.

The FE device 120 and LOE 130 are surrounded by, or encased in, an ambient material 160, having a low refractive index, n160. The value of n160 may be, for example, between 1.0 and 1.36.

The rays of fields 110a, 110b, and 110c are shown in FIG. 1 as being refracted in succession at the ambient-FE interface on surface 120c and at the FE-LOE interface on surface 130a. The incident and refracted angles at the FE-LOE interface are denoted by θ120 and θ130, respectively. For example, the value of 0120 may be in a range of 35 deg. to 50 deg. The value of the refracted angle θ130 satisfies Snell's law, namely:

sin(θ130)=(n120/n130)sin(θ120) equation (1)

After refraction at the FE-LOE interface, the light advances in the direction of the X-axis of the LOE, and is reflected at the oblique surface 130c. The reflected light undergoes refraction, typically by a small amount, at the LOE-ambient interface on surface 130b of the LOE, and then passes from the LOE to the eye of an observer.

The projected angular aperture 150 corresponds to the angle subtended by all light leaving the LOE. A dimensionless expansion ratio of the FE device is defined as the projected angular aperture 150 divided by the incident angular aperture 110. Exemplary values of the expansion ratio are between one and 1.60.

The following table shows exemplary numerical results generated by an optical ray-tracing simulation of the optical configuration in FIG. 1.

TABLE 1

| | | |
|---|---|---|
| | Case 1 | Case 2 |
| Parameter | Value | Value |

| | | | | |
|---|---|---|---|---|
| 120a | 39.9 | deg | 47.8 | deg |
| 120b | 58 | deg | 41 | deg |

| | | |
|---|---|---|
| n120 | 1.94 | 1.94 |
| n130 | 1.6 | 1.6 |

| | | | | |
|---|---|---|---|---|
| θ120 | 39.9 | deg | 47.8 | deg |
| θ130 | 51 | deg | 64 | deg |
| 150 | 32.6 | deg | 32.6 | deg |
| 110 | 26.1 | deg | 19.8 | deg |

| | | |
|---|---|---|
| Expansion Ratio | 1.25 | 1.6 |

To understand the practical utility of the FE device, consider, for example, a POD having a FOV aspect ratio of 3:4. If, as in case 1, an expansion ratio of 1.25 is applied to the larger side of the FOV, the projected image will have an aspect ratio of 3:(4×1.25)=3:5, or approximately the projected image format of a 10:16 elongated rectangular FOV. The utility of the FE device is even greater in case 2. In this case the expansion ratio is 1.60. Thus, a square-shaped POD, i.e. having an aspect ratio of about 1:1, can be used to provide a 10:16 projected image format, where the expansion is preferably applied to the smaller FOV axis.

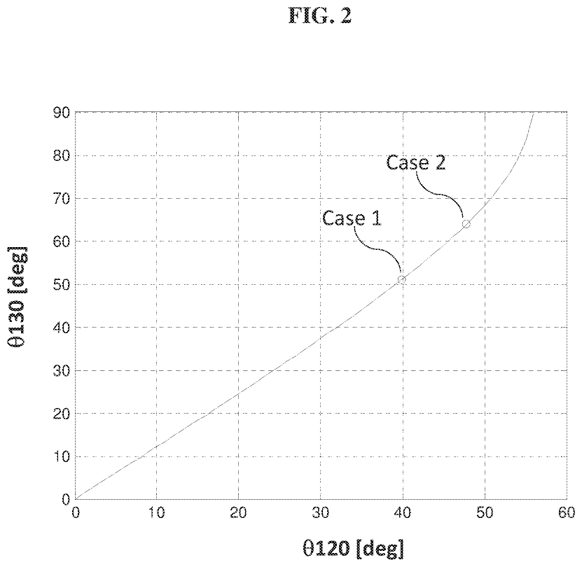

FIG. 2 is an exemplary graph showing the nonlinear relationship between the incident angle θ120 in degrees, on the horizontal axis, and the refraction angle θ130 in degrees, on the vertical axis, according to equation (1). At small values of the incident angle θ120, the graph is approximately linear with a slope equal to n120/n130=1.94/1.60=1.21. The circles indicate points corresponding to cases 1 and 2 in Table 1. At these points, the graph is significantly nonlinear, and the slope is not only greater than 1.21, but it increases sharply with increasing values of θ120 and θ130.

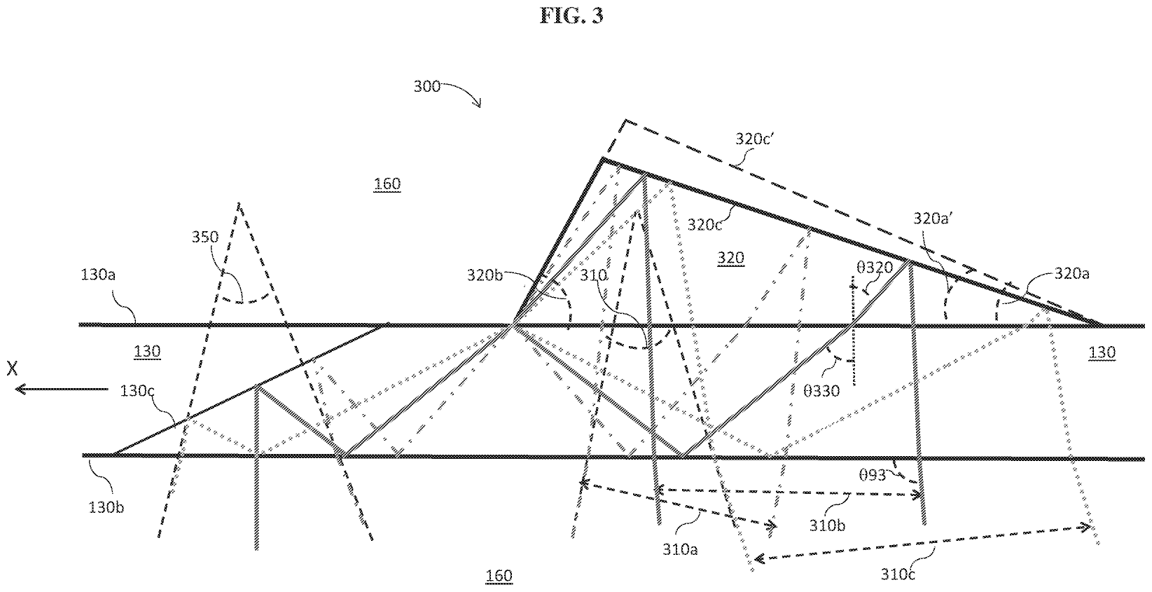

FIG. 3 shows a schematic cross-sectional diagram of an exemplary FE device 320 for coupling light into an LOE 130, according to a second embodiment 300 of the invention. FE device 320 is characterized by a prismatic shape similar to that of FE device 120. The interior vertex angles are 320a, 320b, and 180°−(320a+320b). Exemplary ranges for 320a and 320b are the same as those for the corresponding vertex angles 120a and 120b in FIG. 1.

In this embodiment, the FE device 320 has a mirrored surface 320c. Light from the POD, in a multiplicity of incident illumination fields 310a, 310b, and 310c, first passes through surface 130b of the LOE 130 and then is reflected back to the LOE by the mirrored surface 320c. As in FIG. 1, the rays of the three incident illumination fields are distinguished by dot-dashed lines for field 310a, by solid lines for field 310b, and by dotted lines for field 310c. The incident angular aperture 310 corresponds to the angle subtended by light from all the illumination fields entering the LOE 130.

After refraction at the FE-LOE interface as indicated by angles θ320 and θ330, the light advances in the direction of the X-axis of the LOE, and is reflected at the oblique surface 130c. The reflected light undergoes refraction, typically by a small amount, at the LOE-ambient interface on surface 130b of the LOE, and then passes from the LOE to the eye of an observer.

The projected angular aperture 350 corresponds to the angle subtended by all light leaving the LOE. A dimensionless expansion ratio of the FE device 310 is defined as the projected angular aperture 350 divided by the incident angular aperture 310. Exemplary values of the expansion ratio are between one and 1.60.

In FIG. 3, the rays of illumination field 310b enter the LOE at an angle θ93, which deviates slightly from the normal to the surface 110b. The angle θ93 may be adjusted by varying the vertex angle 320a, namely, the angle between the reflective surface 320c and the LOE surface 130a.

In embodiment 300, one may use, for example, a dense flint glass having a refractive index n320 whose value is similar to that of FE device 120. The FE principle is the same as in the embodiment 100. Use of a glass material with a lower value of n320, for example closer to that of the LOE 130, is inadvisable for very compact NED systems. The reason is that, to achieve comparable FOV expansion, reducing n320 would generally necessitate enlarging the FE device, as indicated by the dashed line 320c′ and the larger vertex angle 320a′. The latter would increase the protrusion of the FE device from the surface 130a of the LOE.

In some cases the output image may suffer from chromatic aberrations and/or keystone effects. These effects may be mitigated by optical corrections applied to the POD optics and/or by electronic corrections applied to an SLM. The use of narrow bandwidth illumination sources, such as lasers, is also useful in reducing chromatic aberrations.

In the above description, the invention has been illustrated with the FE device placed proximal to a surface of an LOE. More generally, the LOE may be replaced by another type of NS optical element or by an NS optical element which couples light out through a diffractive optical element.

Although the invention has been illustrated for the case of three incident illumination fields, it should be evident to those skilled in the art of optical design that the invention is applicable more generally to one or more incident illumination fields.

Furthermore the FOV expansion, which is illustrated in FIGS. 1 and 3 in one spatial dimension using planar geometry, may also be applied in more than one spatial dimension. This may be accomplished for example by the use of multiple FE devices.

It will be appreciated that the above descriptions are intended only to serve as examples, and that many other embodiments are possible within the scope of the present invention as described above and as defined in the appended claims.

1. An optical field of view (FOV) expansion device for use in a near-eye display, the device comprising
a first surface configured to receive incident illumination from a projector of display (POD) of the near-eye display, the incident illumination having an incident angular aperture;
a second surface forming a vertex angle with the first surface; the second surface being proximal and substantially parallel to a surface of a non-sequential (NS) optical element;
the NS optical element projecting light having a projected angular aperture;
wherein,
a refractive index of the device is greater than that of the NS optical element; and
a FOV expansion ratio of the device, defined as a ratio between the projected angular aperture and the incident angular aperture, is greater than or equal to a pre-determined threshold value.

2. The device of claim 1 wherein the first surface is optically transparent to the incident illumination.

3. The device of claim 1 wherein the first surface optically reflects the incident illumination.

4. The device of claim 1 wherein a projected image aspect ratio is greater than a POD aspect ratio by a factor equal to the FOV expansion ratio.

5. The device of claim 1 wherein the pre-determined threshold value is 1.2.

6. The device of claim 1 wherein the FOV expansion ratio increases with an angle of incidence of the incident illumination.

7. The device of claim 6 wherein the angle of incidence is between 35 degrees and 50 degrees.

8. The device of claim 1 wherein the refractive index of the device is between 1.70 and 1.94.

9. The device of claim 1 wherein the device is comprised of an optical flint glass material or an optical acrylic material.

10. The device of claim 1 wherein the vertex angle has a value between 35 degrees and 50 degrees.

11. The device of claim 1 wherein the NS optical element is a light-guide optical element.

12. The device of claim 1 wherein the incident illumination includes a multiplicity of incident illumination fields.

13. The device of claim 1 wherein the device introduces optical aberrations and/or optical distortions which are compensated by corrections applied to the incident illumination from the POD.

14. The device of claim 13 wherein the corrections are applied by a spatial light modulator and/or by corrective optical elements.

15. The device of claim 1 wherein the incident illumination is provided by one or more narrow-band illumination sources, so as to limit an effect of chromatic aberration.

16. The device of claim 1 wherein the NS optical element couples light out through a diffractive optical element.
